(19) United States
(12) Patent Application Publication
(10) Pub. No.: US 2008/0201287 A1
(43) Pub. Date: Aug. 21, 2008

(54) Dissimilar item recommendation method, device, and program thereof

(75) Inventor: Masaru Takeuchi, Kodaira (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/068,701

(22) Filed: Feb. 11, 2008

(30) Foreign Application Priority Data
Feb. 21, 2007 (JP) 2007-040536

(51) Int. Cl. G06N 5/02

(52) U.S. Cl. 706/46

(57) ABSTRACT

Recommendation method and device for selectively and by priority recommending to the user an item assumed highly unexpected to the user. A user accesses an item A using the selector unit of a client, and accesses an item B in a time period within a specified threshold, moreover when there is a low degree of similarity between item A and item B, a server forms A and B into a pair (A,B) and stores it in a neighboring selective item pair database. When another user accesses an item similar to A, then an item Y similar to item A or item B is recommended to the client unit by using the pair (A, B) recorded in the neighboring selective item pair database.

### CLAIM OF PRIORITY

The present application claims priority from Japanese application JP 2007-040536 filed on Feb. 21, 2007, the content of which is hereby incorporated by reference into this application.

### FIELD OF THE INVENTION

The present invention relates to a recommendation technology in the artificial intelligence field for providing items such as products and TV programs matching a user's preferences for urging the user to purchase a product or view a program.

### BACKGROUND OF THE INVENTION

There are two known methods for recommending items in the artificial intelligence field. One method recommends only similar items. This method recommends similar items to users by utilizing attributes that characterize the item and is usually called the Contents-Based Recommendation method. The other method can recommend dissimilar items. This method does not utilize the item attributes, and sometimes recommends dissimilar items to the user. A typical technique in this method is called collaboration filtering (IEEEJ Technical Report AI2006-3 “Collaboration Filtering Method based on Peripheral Rating Distribution”). This method recommends items by utilizing selection trends of another user that are similar to the selection trends of the target user for the recommendation.

JP-A No. 326227/2004 points out the problem that items recommended in collaboration filtering of the related art are determined collectively for all users based on the user rating of an item and selection behavior, and therefore does not cover the speed of changes in user preferences or the intensity of individual preferences, the newness of a desired item. The related art therefore has the problem of being unable to recommend an appropriate item to all users. To resolve this problem the information provision method of JP-A No. 326227/2004 recommends a portion of items from among multiple candidate items for recommendation. This information provision method attaches a rating date and rank to the user ratings of an item and stores it as history data and, acquires a (time) period setting for use in deciding an item to recommend to the user, and then decides the item to recommend to the user based on history data whose rating date is within a specified period within the history data. This information provision method in particular recommends appropriate items to all users by setting simple parameters such as the number of similar users, recommendation period and learning period for each user, assuming that there is a differential between long-term user preferences and short-term user preferences.

In other words, JP-A No. 326227/2004, assumes a differential between long-term user preferences and short-term user preferences, and makes use of all user selection items within a fixed time period and controllable by parameters, as history data for making recommendations.

### SUMMARY OF THE INVENTION

The content based item recommendation method recommends only similar items. This method recommends items estimated to be liked by the user based on item attributes and user attributes. However, when using item selections made by that user as a key for recommending other items, this method can only recommend items similar to the item attributes serving as the key.

Collaboration filtering in the technology of the related art is one recommendation method that does not utilize item similarity. Recommendation results from this method may include low similarity items. However, the user cannot find which items have a low similarity solely from the recommendation results from the collaboration filtering.

An object of this invention is to provide a method, device and program for making item recommendations, and suggest unexpected items, by way of an item recommendation method in which the server suggests items matching user preferences by way of a network to the user terminal.

In order to achieve the above object, this invention provides a dissimilar item recommendation method for suggesting items matching with at least one item of interest entered by a user, in which the server selects or suggests by priority, items with low similarity to the item of interest among multiple attribute sets expressing the item characteristics thereof; as a method for suggesting items matching user preferences via a network to the user terminal. This invention further provides a dissimilar item recommendation method in which the server records a pair of items selected by the user in a time period and within a specified threshold, and suggests items utilizing the information in the recorded item pair.

In other words, this invention records pairs (neighboring selected item pairs) of items selected (simultaneously and consecutively) in a short time period and within a specified threshold and utilizes these pairs to make recommendations. This method founded in the concept that there is some relation in selections made within a short time period. This invention assumes there is a connection or relation between consecutively selected items in the history data used in the recommendations. The history data used in the recommendations makes use of item pairs selected within a short time period and without establishing any time domain for the recommendation.

Here we define a short time period as a period of time within a specified threshold determined absolutely and relatively. More specifically, when for example viewing TV or video (programs), there is a time period within one second immediately before or after the user has changed the channel title, a time period within about two to three minutes where the channel is consecutively changed, and a period within about two to three hours assumed for continuously viewing television. Likewise, when purchasing products on a shopping site, there is a time period of about two to three hours between logging in and logging out of the site, and a time period of about two to three weeks where purchases are made several times. Numerical values for these time periods may sometimes be applied relatively in the form of several percent of an average time period expressing the user's selection behavior.

A relation or connection in selection behavior is a relation in same genre such as among action, love romance, and science fiction in TV and video viewing, a relation among favorite actors appearing in roles, or a relation due to a user's latent viewing pattern such as wanting to see a drama after watching a baseball program. In product purchase behavior at shopping sites, relations include purchasing craft tape as a necessary accessory item after purchasing a cardboard box, or a purchasing a preferred coordinate item such as a muffler that matches gloves that were selected for purchase.

Preferably the system accesses an item B immediately after the user accesses an item A, and stores the A and B relation as a neighboring selection item pair (A, B) where the similarity between item A and item B is low. Then, when the user has accessed an item X similar to A, the system utilizes the neighboring selection item pair (A, B) to recommend the item B or the item Y that resembles the item B.

This invention also provides a means for specifying recommendation results from recommendation methods such as collaboration filtering that do not utilize the similarity among items, selectively or by priority to the user in the order of low item similarity, so that the user is specifically presented with low similarity items.

In this invention, unexpectedness in recommending an item, is unexpectedness versus the recommendation result for the target user; and when there is little similarity in item attributes, then those are called unexpected recommendation results.

In this way, a method for recommending unexpected items based on the implicit similarity or relation among items can be provided, and has a roll as memorandum for forgetting.

Preferably the system becomes capable of recommending an item Y that is related to but not similar to item X, in the order of; an item A that is similar to item X, an item A and an item B selected within a short time period, and an item Y that is similar to an item B. Rather than recommending unexpected items, the utilizing of neighboring item pairs just by individual users might be called a defensive item recommendation that induces serendipity (discovery) to occur. In contrast, when using neighboring selected item pairs from other (multiple) users, a relation within neighboring selected item pairs may be usable that was never considered by the individual user, and this relation then allow recommending an unexpected item.

Also, by providing recommendation results in order of low similarity by techniques such as collaboration filtering that do not utilize the similarity among items, allows providing the user by priority, with items of high unexpectedness as defined above.

The two embodiments of this invention for recommending items possessing unexpectedness are described next while referring to the drawings.

### BRIEF DESCRIPTION OF THE DRAWINGS

FIG. 1 is a block diagram showing the recommendation system for specifying the degree of similarity in the first embodiment of this invention;

FIG. 2 is a table for describing the data structure (user/item matrix) of collaboration filter of the first embodiment;

FIG. 3 is a PAD diagram showing the registration process flow in the collaboration filter of the first embodiment;

FIG. 4 is a PAD diagram showing the recommendation process flow in the collaboration filter of the first embodiment;

FIG. 5 is a data structural diagram for the item/attribute database of the first embodiment;

FIG. 6 is a PAD diagram showing the process flow for calculating the degree of similarity in the first embodiment;

FIG. 7 is a diagram of the display interface utilizing the degree of similarity in the first embodiment;

FIG. 8 is a block diagram of the recommendation system using neighboring selection item pairs in the second embodiment of this invention;

FIG. 9 is a diagram of the data structure for the neighboring selection item pair database of the second embodiment;

FIG. 10 is a PAD diagram showing the process flow for registering the neighboring selection item pair of the second embodiment;

FIG. 11 is a PAD diagram for showing the process flow for recommending via a neighboring selection item pair in the second embodiment; and

FIG. 12 is diagram of the display interface for neighboring selection in the second embodiment.

### DETAILED DESCRIPTION OF THE PREFERRED EMBODIMENTS

### First Embodiment

### 1. Recommendation System for Specifying Similarity

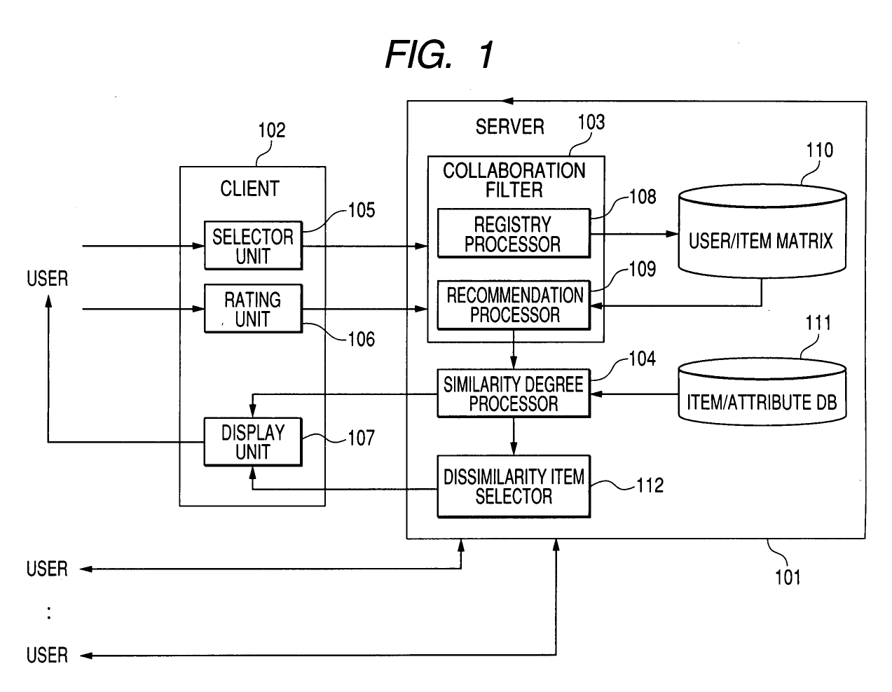

FIG. 1 shows the overall structure of the recommendation system for specifying the degree of similarity of the first embodiment. This recommendation system is made up of a server 101 and multiple clients (user terminals) 102. The server 101 is a computer system including a central processing unit (CPU) as a processing unit, and a storage unit, and as a functional structure includes a collaboration filter 103 and a similarity degree processor 104. This functional structure is normally executed by programs implemented by the CPU serving as a processor. In addition to these execution programs, the storage unit contains a user/item matrix and item/attribute DB described later on. The client 102 is a normal personal computer (PC) including a display device and a keyboard serving as an input/output device. The client 102 includes an item selector unit 105 and an item rating unit 106 for the user and a display unit 107 for displaying information relating to recommendation items for the user.

The collaboration filter 103 in server 101 contains a registry processor 108 for user item selection and rating results in the user/item matrix 110, and an item recommendation processor 109 for the user that utilizes the user/item matrix 110 described later on. The similarity degree processor 104 calculates the degree of similarity between items by utilizing the contents of the item/attribute database (DB) 111 for recording item attributes. Also, a dissimilarity item selector 112 selects items with a low degree of similarity by using results from the similarity degree processor 104 and provides them to the user using the display unit 107.

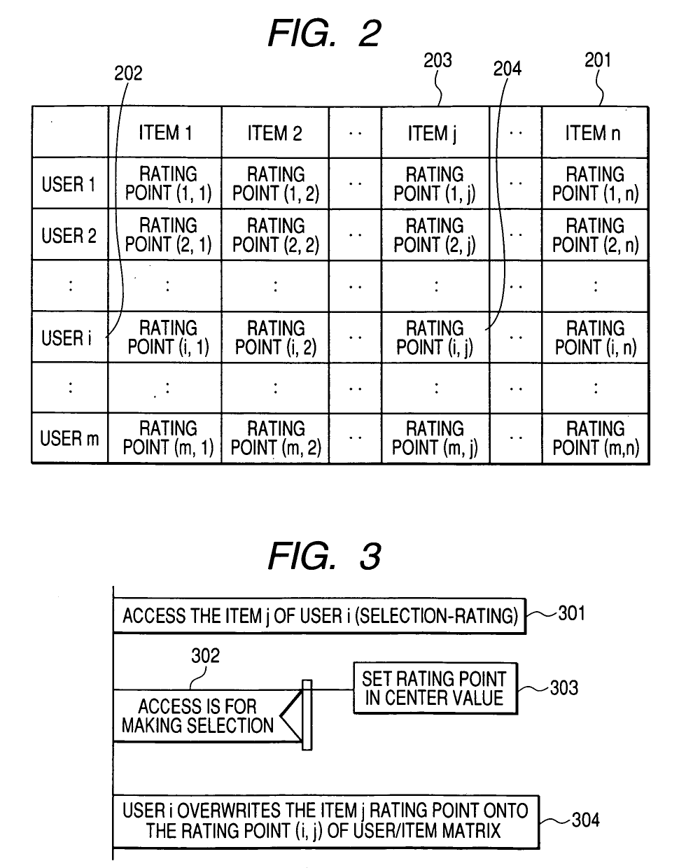

There are a number of techniques in the related art for implementing the collaboration filter but this embodiment utilizes the k nearest neighbor method. FIG. 2 shows one example of the data structure of the nearest neighbor method in the collaboration filter. This data is called the user/item matrix 201. A user 202 is shown in the line direction and the item 203 as shown along the row direction and an index applied to each item and user is recorded here. A rating point 204 is recorded in each element of the matrix. The rating point is information that the user 202 has selected the item 203, or is information expressing a rating value given to the selected item. The rating point 204 field remains blank if the user 202 has not selected an item 203 or made a rating.

FIG. 3 is a PAD (Problem Analysis Diagram) showing the registry processor 108 for the collaboration filter 103. The user i as the client 102 first of all, accesses (301) item j for a selection action or a rating action for a formerly selected rating item. If a rating action then the rating the user i gave to item j is allotted as a number. Next, the registry processor 108 of collaboration filter 103 within the server 101 in FIG. 1, decides if the access is for a selection action or a rating action (302). If a selection action then the rating point is set as a center value in the rating value region (303). Here, the center values is a value in the middle of the rating value steps and here is the number 3 among the five steps {1, 2, 3, 4, 5} of the rating value region. Next, the user i overwrites the rating value of item j, onto the rating value (i, j) of the user/item matrix. Selection results and rating results are in this way recorded onto the user items in the user/item matrix 201 in FIG. 2.

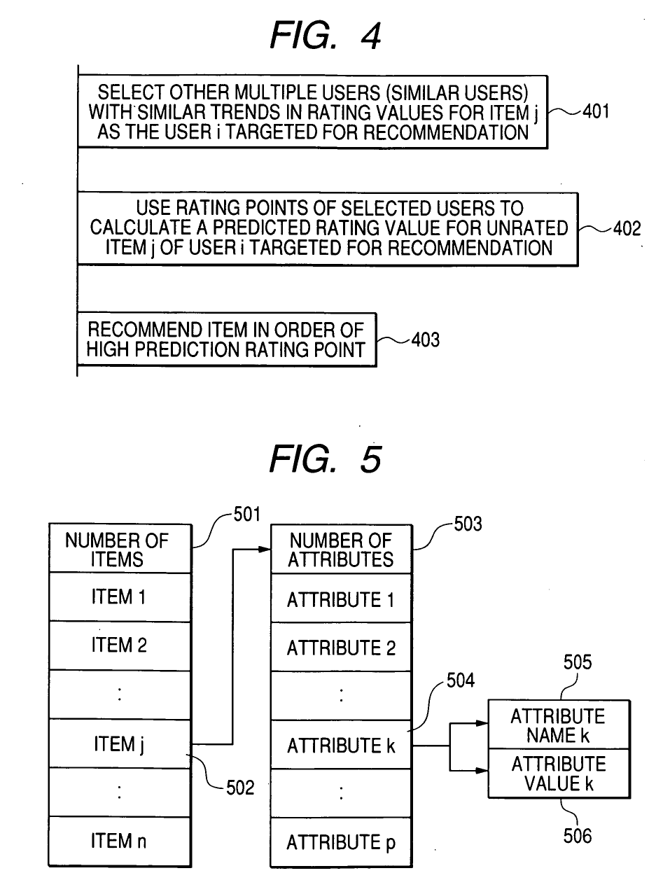

FIG. 4 is a PAD diagram showing the recommendation process flow in the collaboration filter.

The collaboration filter 103 of server 101 recommends items to the user by utilizing the user/item matrix 201 in FIG. 2. First of all, the collaboration filter 103 selects other multiple users (similar users) with similar trends in rating values for item j as the user i targeted for recommendation (401).

To select similar users, the rating vector v(i) for the user i is for example set as:

V(i)=(rating value (i, 1), rating value (i, 2), . . . , rating value (i, j), . . . , rating value (i, n)) (Eq. 1)

and,

the cosine similarity w for previous rating data applied to both user i and the other users is calculated as:

w(i, I′)={v(i)·v(i′)}/{|v(i)|×|v(i′)|} (Eq. 2)

and high-order k persons with a high value W and for the pre-established number of persons are selected for this value The cosine degree of similarity for non-rated items is set to 0. The “·” in equation 2 is the inner product (dot product) of the vector.

Using the selected rating point value for the selected users, a predicted rating value is next calculated for the unrated item j of the user i targeted for recommendation (402). The set of similar users for the selected k persons is expressed as S, and the prediction value r (i, j) for value applied to item j of the user i targeted for recommendation is given by the following equation.

r(i, j)=Σ_{i′εS}[w(i, i′)×{rating value(i′, j)−mean rating value (i′)}]/{Σ_{i′εS}|w(i, i′)|}+mean rating value (i) (Eq. 3)

Here, the mean rating value is the average of the rated values for items already rated for user i′. The relative rating value for similar users is found by subtracting the mean rating value, and setting that value as the weighted means per the degree of similarity between the recommendation target user and similar users and, summing the mean values for the recommendation targeted user. Finally, the items are recommended from these prediction values in the order of high values first (403).

FIG. 5 shows the data structure of the item/attribute database (DB) 111. The reference numeral 501 denotes the number n of the recorded items. The number for attribute 504 shown by attribute number 503 is recorded in item j of 502.

The attributes are a pair of the attribute name 505 and the attribute value 506. For example, for an item attribute called “umbrella”; an attribute value “67.5 cm” is paired with the attribute name “size”; and an attribute value “black” is paired with the attribute name “color”, and the “16 pcs.” is given to the attribute name called “number of bones”.

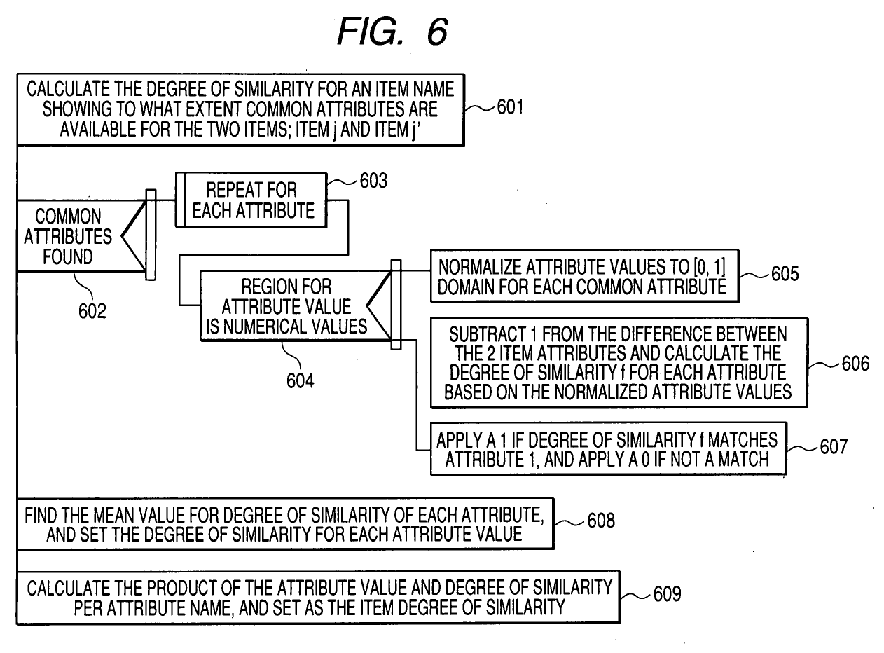

Next, FIG. 6 shows an example of the process flow for calculating the degree of similarity in the similarity degree processor 104 in the server 101.

The similarity degree processor 104 first of all calculates the degree of similarity for an attribute name showing to what extent common attributes are available for the two items; item j and item j′ (601). Next, the similarity degree processor 104 calculates the degree of similarity of attribute values for attributes common to the two items (602-608) and calculates the item's degree of similarity (609). The degree of similarity for an attribute name is the number of elements in the set #(*) for the set A (j′) for the attribute name of item j′ and the set A (j) for the attribute name of item j and is determined as follows.

R₁(j, j′)=#(A(j)∪A(j′))/#(A(j)∪A(j′)) (Eq. 4)

This serves as a marker for making comparisons when judging similarity or in other words, showing to what extent attributes possessing common attribute names are available or not.

In determining similarity of attribute values, the similarity degree processor 104 first decides whether there is a common attribute for two items (602). If there is a common attribute then the following procedure is repeated for each attribute (603).

When the range of attribute values is numerical values (604), then the attribute values for each common attribute are normalized in domain [0,1] (605). In other words, when the upper limit and lower limit for the attribute value set are set as bₘₐₓ, bₘᵢₙ, then,

b′(j, k)={b(j, k)−bₘᵢₙ}/{bₘₐₓ−bₘᵢₙ} (Eq. 5)

is obtained.

The similarity degree processor 104 next subtracts the differential in attribute values between the two items from 1 based on the normalized attribute values, and calculates the degree of similarity f (606). In other words, the degree of similarity for the attribute k between item j and item j′ is given by the following equation.

f(j, j′, k)=1−|(b′(j, k)−b′(j′, k)| (Eq. 6)

However, when the attribute value set is a discrete set that is not numerical values (604), then the degree of similarity f(j, j′, k) for attribute k of the two items, item j and item j′ is 1 if the attribute values are a match, and is given as 0 if they do not match (607).

Next, the mean for C overall, with c as a set for attributes possessing common attribute names is found from:

R₂(j, j′)=1/#(C)×Σ_{kεC}{1−|b′(j, k)−b′(j′, k)|} (Eq. 7)

and is set as the degree of similarity for the attribute value (608).

Lastly, the similarity degree processor 104 calculates the product of the attribute value and degree of similarity of the attribute name in the following equation

R(j, j′)=R₁(j, j′)×R₂(j, j′) (Eq. 8)

and sets this as the item degree of similarity (609).

Here, items where this value is high are called similar items, and items where this value is within a pre-established threshold R₀ are called dissimilar items.

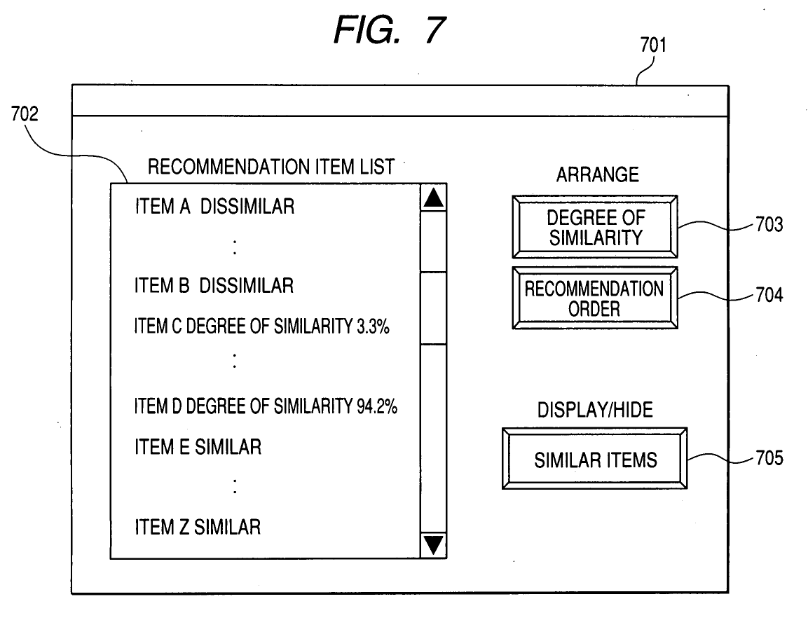

FIG. 7 shows an example of the display interface 701 utilizing the degree of similarity in this embodiment. Results from the collaboration filter 703 and the similarity degree processor 104 of FIG. 1 are displayed on a recommendation item list 702 listing the item degree of similarity. Dissimilar items and similar items where the degree of similarity is 1.0 or in other words 100 percent are specified here as “Dissimilar” and “Similar”. Press the similarity degree button 703 displays recommendation results in ascending order for the degree of similarity calculated in 609 of FIG. 6, on the recommendation item list 702.

This button 703 can display recommendation results to the user in the order of items with high unexpectedness. Pressing the recommendation order button 704 displays recommendation results on a recommended item list 702 shown in descending order for the estimated rating points calculated in 402 of FIG. 4. Pressing the similarity item button 705 switches to hide or display the item within the threshold R₀ whose degree of similarity is predetermined. This button 705 can display only dissimilar items possessing a high degree of unexpectedness.

### Second Embodiment

### 2. Recommendation System Utilizing Neighboring Selection Item Pairs

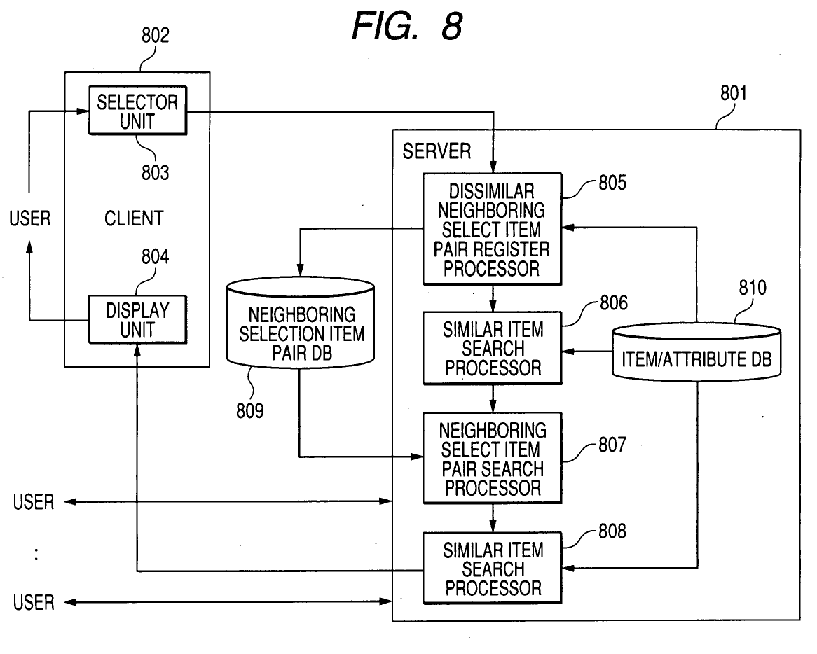

FIG. 8 shows the overall structure of the recommendation system using neighboring selection item pairs in the second embodiment. This system includes a server 801 and multiple clients 802. This server 801 and the multiple clients 802 needless to say, possess the same hardware structure as the server 101 and client 102 of the first embodiment.

The server 801 includes a dissimilar neighboring select item pair register processor 805 and two similar item search processor units 806, 808 and a neighboring item pair search processor unit 807. Each of these function processor units is provided in the form of a program executed on a processor unit making up the server as previously described. The client 802 contains a display unit 804 for displaying information relating to items recommended to the user and the user item selector unit 803. A neighboring select item pair database 809 accumulated in the storage unit records neighboring select item pairs registered by a dissimilar neighboring item pair registry unit 805, and searches these items using a neighboring item pair search processor 807. Two similar item search units 806, 808 calculate the degree of similarity between items using the calculation process flow in FIG. 6, and the contents of the item/attribute database (DB) 810 identical to the item/attribute database (DB) 111 of FIG. 1 for recording the item attributes, and searches for items similar to the allotted item.

The neighboring select item pair is two items selected within a short time period and within a specified threshold preset by the same user as described previously.

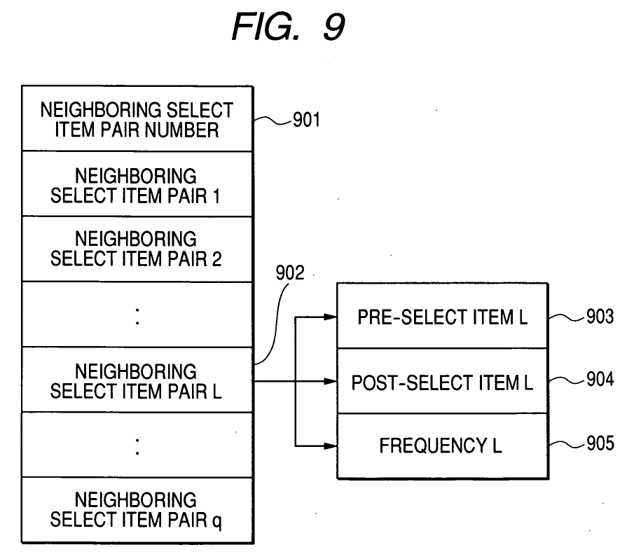

FIG. 9 shows an example of the data structure of neighboring selection item pair database (DB) 809. The neighboring selection item pair database 809 shows the number of neighboring selection item pairs recorded in the neighboring select item/pair database 809 in FIG. 8. The neighboring select item pair number 902 includes a pre-select item 903 selected in advance, a post-select item 904 next selected in a short time period, and a frequency 905 for that neighboring select item pair.

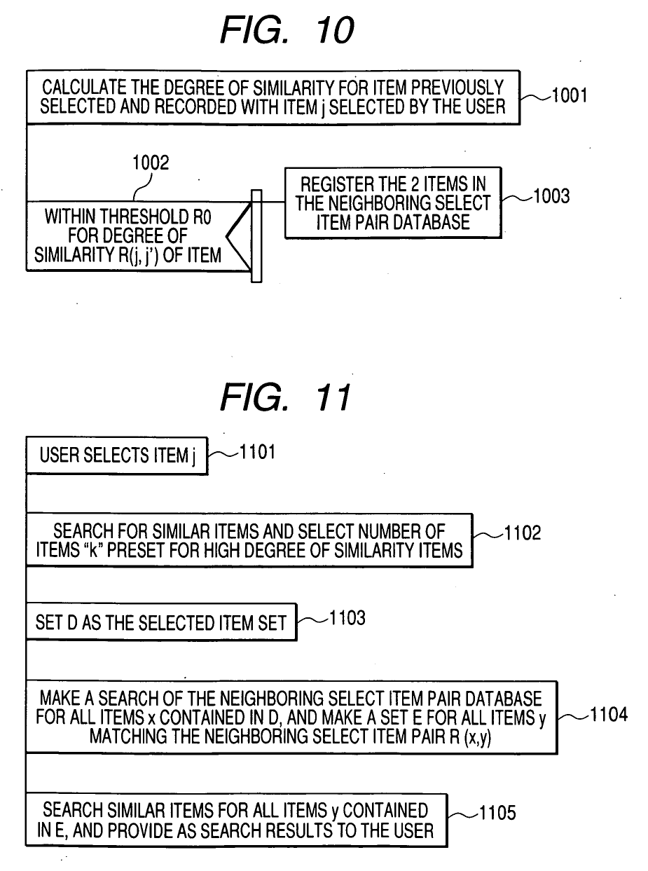

FIG. 10 shows the flow in the process for registering the neighboring select item pair in the dissimilar neighboring select item pair register processor unit 805 executed in the processor unit of server 801. First of all, the degree of similarity for prior selected and recorded item j′ and the item j selected by the user are calculated in the calculation processing flow in FIG. 6 (1001). If the degree of similarity R (j, j′) for these two items, item j and item j′ are within the pre-established threshold R₀, then those two items are registered in the neighboring select item pair DB809.

FIG. 11 shows the recommendation process flow when the neighboring item pair search processor 807 executed by the processor unit in the server 801 searches for a neighboring select item pair. The recommendation process per the neighboring select item pair start when the user selects the item j (1101). First the similar item search unit 806 in FIG. 8 makes a search for similar items, and selects a predetermined “k” number of items having a high degree of similarity (1102). These selected items make up the set D (1103). Here, the set D is a set made up of items similar to the item j selected by the user.

Next, the neighboring item pair search processor unit 807 in FIG. 8 searches the neighboring select item pair DB809 of all items x contained in the set D, and forms a set E of all items y matching the neighboring select item pair R (x, y) (1104). The neighboring select item pair DB809 in FIG. 7 is installed outside the server 801 but needless to say may also be stored in the storage unit within the server 801 the same as the item/attribute DB810.

The set E here is a set of items selected in a short time period and within a threshold and similar items belonging to the set D. The frequency 905 in FIG. 9 establishes an order for the set of items, and limits the number of elements in the set.

Then, the similar item search units 808 in FIG. 8 searches for similar items among all items y contained in set E of the items, and provides the search results to the user (1105).

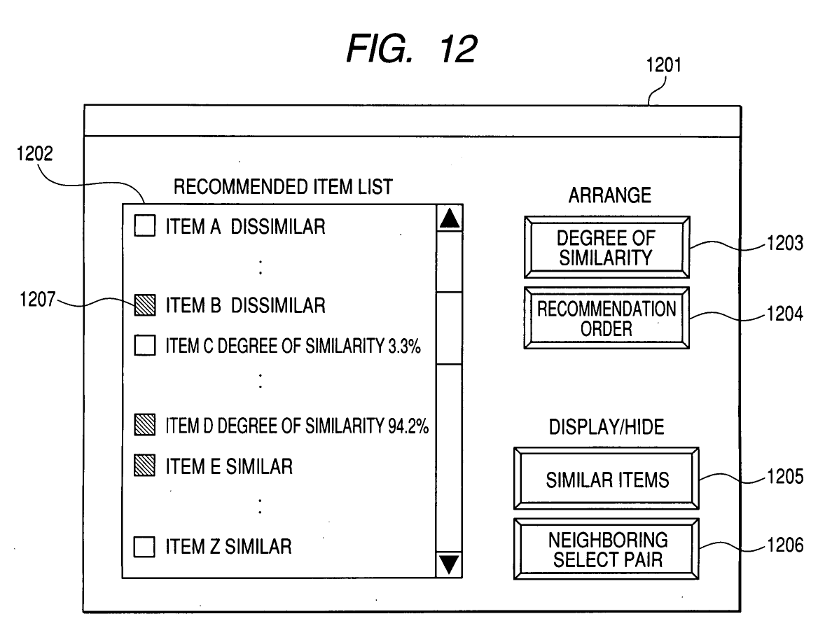

FIG. 12 is diagram of the display interface shown in the display unit 804 of client 802 in this embodiment. Namely, this is a display interface 1201 that received recommendation results from neighboring selection on a display interface utilizing the degree of similarity. Recommendation results from the collaboration filter 103 of FIG. 1, and recommendation results utilizing neighboring selection item pairs and results from the similarity degree processor 104 are displayed on a recommendation item list 1202 where items are allotted by degree of similarity. Among the items on this list, those items that are recommendation results utilizing neighboring selection item pairs are marked and displayed (1207). Pressing the similarity button 1203, makes the recommendation item list 1202 display recommendation results for degree of similarity calculated in 609 of FIG. 6 in ascending order. Pressing this button allows the recommendation item list 1202 to display recommendation results to the user in order of high degree of unexpectedness.

Also, pressing recommendation sequence button 1204 shows recommendation results on recommendation item list 1202 in descending order for predicted rating points calculated in 402 of FIG. 4. Pressing the similar item button 1205 switches between hide or display of items within the R0 threshold preset for degree of similarity. This button (1204) can display only dissimilar items with a high degree of unexpectedness. Pressing the neighboring selection pair button 1206 switches between hide or display of recommendation results via neighboring selection pairs.

The invention as described in detail above can be utilized for recommending diverse types of items for product promotions in marketing, and for recommending products in programs, scenes, and online shopping in television systems and broadcasts.

What is claimed is:

1. A dissimilar item recommendation method for suggesting items matching with at least one item of interest entered by an user via a server over a network to a user terminal, wherein
the server selects or suggests by priority, items with low similarity to the item of interest among a set of multiple attributes expressing item characteristics thereof.

2. The dissimilar item recommendation method according to claim 1, wherein the server calculates the similarity among said set of multiple attributes expressing item characteristics without said multiple attributes expressing item characteristics, and selects or suggests by priority, items with low similarity.

3. The dissimilar item recommendation method according to claim 2, wherein the server utilizes a collaboration filter recommendation method in order to calculate the similarity among said set of multiple attributes expressing item characteristics thereof.

4. The dissimilar item recommendation method according to claim 1, wherein said multiple attributes expressing item characteristics are item names and attribute values.

5. The dissimilar item recommendation method according to claim 1, wherein the server records a pair of items selected by the user in a time period within a specified threshold, and suggests items by utilizing information from the recorded item pair.

6. The dissimilar item recommendation method according to claim 5, wherein the server selectively records an item pair in a database when there is a low degree of similarity among attribute sets of two items making up the item pair.

7. The dissimilar item recommendation method according to claim 6, wherein the server calculates the similarity among said set of multiple attributes expressing item characteristics by searching a preset number of items of higher similarity, selecting a corresponding item to pair with each of their searched preset number of items, and suggesting said corresponding items, wherein said corresponding item is frequently paired with one of said preset number of items in the database.

8. A dissimilar item recommendation device for suggesting items matching with at least one item of interest entered by a user to a user terminal over a network, comprising:
a storage unit; and
a processor unit formed to select or suggest by priority, items with a low similarity to the item of interest among a set of multiple attributes expressing item characteristics thereof.

9. The dissimilar item recommendation device according to claim 8,
wherein the storage unit stores a user/item matrix for recording rating points for multiple items of multiple users, and an item/attribute database for recording multiple attributes expressing item characteristics for those multiple items, and
wherein the processor unit includes:
a recommendation processor unit formed to select and recommend an item based on rating points stored in the user/item matrix;
a similarity calculator processor unit formed to calculate the degree of similarity of an item recommended by the recommendation processor unit by utilizing an item/attribute database; and
a dissimilar item selector unit formed to select dissimilar items based on the degree of similarity obtained from the similarity calculator processor unit.

10. The dissimilar item recommendation device according to claim 9, wherein the recommendation processor unit implements the collaboration filter recommendation method.

11. The dissimilar item recommendation device according to claim 8,
wherein the storage unit stores a neighboring selection item pair database for recording information on two time pairs selected by the user in a time period within a specified threshold, and
wherein the processor unit includes a neighboring item pair search processor unit formed to search the neighboring selection item pair database stored in the storage unit and suggests items utilizing information on item pairs recorded in the neighboring selection item pair database.

12. The dissimilar item recommendation device according to claim 11, wherein the processor unit includes a dissimilar neighboring selection item pair registry processor unit formed to selectively register the applicable item pair in the neighboring selection item pair database, when there is a low degree of similarity among attribute sets of two items composed of the attribute pair.

13. A dissimilar item recommendation program embedded in a computer readable storage medium to suggest items match with at least one item of interest entered by a user to a user terminal over a network, comprising:
a module for selecting or suggesting by priority, items with low similarity to the item of interest among a set of multiple attributes expressing item characteristics thereof.

14. The dissimilar item recommendation program according to claim 13, further comprising:
a module for using a user/item matrix for recording rating points for multiple items of multiple users,
a module for storing multiple attributes expressing item characteristics for those multiple items in an item/attribute database,
a module for selecting and recommending items based on rating points stored in the user/item matrix,
a module for calculating the degree of similarity of the recommended item by utilizing the item/attribute database, and
a module for selecting the dissimilar item based on the degree of similarity that was obtained.

15. The dissimilar item recommendation program according to claim 14, further comprising a module for implementing the collaboration filter recommendation method when selecting and recommending the item.

16. The dissimilar item recommendation program according to claim 13, further comprising:
a module for utilizing a neighboring selection item pair database stored within the storage unit for recording information on the two item pairs selected by the user in a time period within the specified threshold,
a module for searching the neighboring selection item pair database stored in the storage unit, and
a module for suggesting items utilizing information on the item pair that was recorded.

17. The dissimilar item recommendation program according to claim 16, further comprising:
a module for selectively registering the item pair in the neighboring selection item pair database when the degree of similarity of the attribute sets of two items making up the item pair is low.
